(19) United States
(12) Patent Application Publication
(10) Pub. No.: US 2025/0077278 A1
(43) Pub. Date: Mar. 6, 2025

(54) Constraint Programming-Based Periodic Task Scheduling

(71) Applicant: Oracle International Corporation, Redwood Shores, CA (US)

(72) Inventors: Michael Patrick Colena, Hollis, NH (US); Gao Chen, Belmont, CA (US)

(73) Assignee: Oracle International Corporation, Redwood Shores, CA (US)

(21) Appl. No.: 18/457,126

(22) Filed: Aug. 28, 2023

(51) Int. Cl. G06F 9/48

(52) U.S. Cl. CPC G06F 9/4887; G06F 2209/485

(57) ABSTRACT

Techniques for constraint programming-based periodic task scheduling are disclosed, including: determining a set of tasks to be scheduled across a set of shared resources, the set of tasks including multiple periodic tasks; filtering out one or more high-utilization tasks from the set of tasks to be scheduled; generating a constraint programming (CP) model based on the set of tasks, the CP model including a set of constrained variables, a set of constraints, and a search directive; applying a CP solver to the CP model, to obtain a CP solution for scheduling the set of tasks across the set of shared resources; where the CP solution assigns two or more of the periodic tasks to a same resource in the set of shared resources, based at least on the two or more periodic tasks having periods that are harmonically compatible.

### TECHNICAL FIELD

The present disclosure relates to periodic scheduling. In particular, the present disclosure relates to computer programming techniques for scheduling periodic tasks.

### BACKGROUND

Periodic tasks (also referred to as periodic repetitive tasks) are tasks that are executed repeatedly according to a fixed period. A given periodic task has a predetermined time (i.e., the period) between successive executions of that task. In some cases, multiple periodic tasks compete for a limited set of computing resources. Successfully scheduling multiple periodic tasks that use the same computing resources involves planning a start time for each task in a manner that respects deadlines, avoids resource contention, and minimizes resource usage. Failure to coordinate periodic task schedules can lead to resource usage spikes, which may result in missed deadlines and/or resource overutilization.

Some approaches to scheduling periodic tasks assign the tasks to a static schedule. However, circumstances may arise that cause an existing static schedule to become insufficient. Task durations may be over- and/or under-estimated, new tasks may arise that need to be accommodated, and/or activity needs may evolve. Imprecise or out-of-date scheduling of tasks can lead to a state where resources are not utilized optimally, which in turn can cause resource conflicts, service degradation, and increased operational costs.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment and mean at least one. In the drawings:

FIG. 1 illustrates a system in accordance with one or more embodiments;

FIG. 2 illustrates an example set of operations for constraint programming-based periodic task scheduling in accordance with one or more embodiments;

FIG. 3 illustrates an example set of operations for generating a constraint programming model in accordance with one or more embodiments;

FIG. 4 illustrates an example set of operations for constraint programming solving in accordance with one or more embodiments;

FIG. 5 illustrates an example of periodic tasks in accordance with one or more embodiments;

FIGS. 6A-6B illustrate an example of constraint programming-based periodic task scheduling in accordance with one or more embodiments; and

FIG. 7 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form, in order to avoid unnecessarily obscuring the present invention.
1. GENERAL OVERVIEW
2. EXAMPLE SYSTEM
   2.1. SYSTEM COMPONENTS
   2.2. DATA STORAGE
   2.3. USER INTERFACE
   2.4. TENANTS
3. CONSTRAINT PROGRAMMING-BASED PERIODIC TASK SCHEDULING
   3.1. SCHEDULING OVERVIEW
   3.2. GENERATING A CONSTRAINT PROGRAMMING MODEL
   3.3. CONSTRAINT PROGRAMMING SOLVING
4. EXAMPLE EMBODIMENTS
   4.1. PERIODIC TASKS
   4.2. SCHEDULING
5. PRACTICAL APPLICATIONS, ADVANTAGES, AND IMPROVEMENTS
6. COMPUTER NETWORKS AND CLOUD NETWORKS
7. MICROSERVICE APPLICATIONS
   7.1. TRIGGERS
   7.2. ACTIONS
8. HARDWARE OVERVIEW
9. MISCELLANEOUS; EXTENSIONS

### 1. GENERAL OVERVIEW

One or more embodiments use a constraint programming model and associated search directive to determine optimal schedules for periodic tasks. Approaches described herein can be applied to situations where task scheduling needs are changing dynamically, where optimal scheduling demands corresponding adaptations to those changes. One or more embodiments balance resource utilization across the horizon, reducing resource contention and avoiding deadline failures.

One or more embodiments recommend and/or implement task schedules based on analysis of task repeat intervals and worst-case processing time. Scheduling based on analysis of historical usage patterns can improve scheduling and thereby help optimize resource utilization. Given a set of periodic tasks with an execution repeat period and duration, one or more embodiments compute a start time for each task that optimizes for resource utilization, minimizes total resource needs, avoids resource contention, and meets task deadlines. One or more embodiments can further accommodate tasks having fixed start times, which may affect the scheduling of other tasks.

The declarative nature of constraint programming is well-suited for application to a high-level model that addresses the dynamic adaptive periodic scheduling problem. A high-level model may also be more intuitive than a programmatic approach for a developer and/or end-user to understand and work with. Approaches described herein provide a clear separation between the model of the problem and the process of searching for a solution, which allows for more flexibility and ease of maintenance. Constraints can be added or removed in a plug-and-play fashion, without affecting the rest of the model or the search. Similarly, different search preferences can be implemented without changing the model. Thus, declarative approaches described herein are efficient and scalable, and are readily adaptable to evolving objectives.

One or more embodiments described in this Specification and/or recited in the claims may not be included in this General Overview section.

### 2. EXAMPLE SYSTEM

### 2.1. System Components

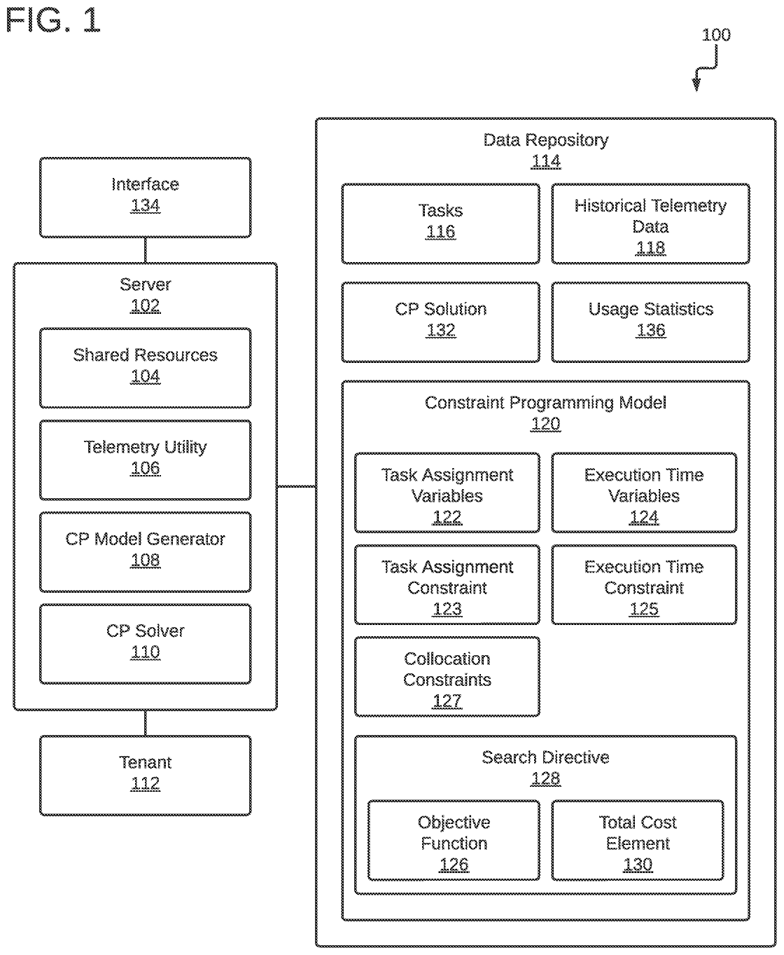

FIG. 1 illustrates an example of a system 100 in accordance with one or more embodiments. As illustrated in FIG. 1, the system 100 includes a server 102, data repository 114, interface 134, tenant 112, and various components thereof. Each of these components is described in further detail below.

In an embodiment, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in the section titled “Computer Networks and Cloud Networks.”

In an embodiment, server 102 refers to hardware and/or software configured to perform operations for constraint programming-based periodic task scheduling, examples of which are described below. Specifically, server 102 is configured to generate a schedule for tasks 116 that use a set of shared resources 104. Shared resources 104 are computing resources that are utilized by multiple users and/or processes concurrently and/or in turns. For example, shared resources 104 may include cloud computing resources such as virtual machines, storage, networking services, etc. In an embodiment, shared resources 104 include multiple sets and/or subsets of resources, and server 102 is configured to generate a schedule that assigns tasks 116 across the shared resources 104.

In an embodiment, a task 116 may be any kind of computer-implemented task that uses one or more shared resources 104. Tasks 116 may range from simple operations like arithmetic calculations, text processing, and data input/output, to more complex operations such as running simulations, executing algorithms, processing multimedia data (e.g., images, videos, and/or audio), or managing large databases. A task 116 may be a periodic task, meaning there is a predetermined interval between subsequent executions of that task 116. A period may be measured in nanoseconds, seconds, minutes, hours, days, and/or some other time unit or combination thereof. In some embodiments, tasks 116 include one or more periodic tasks and one or more non-periodic tasks. Two periodic tasks are considered “harmonically compatible” if one task's period is evenly divisible by the other task's period. For example, given task A with a period of 2 seconds, task B with a period of 3 seconds, and task C with a period of 8 seconds, tasks A and C are harmonically compatible tasks.

One or more embodiments leverage harmonic compatibility between two or more periodic tasks to help optimize scheduling, by ensuring that collocated tasks do not overlap in a way that might consume more than the available shared resources 104. In addition, one or more embodiments exclude non-periodic tasks from colocation with periodic tasks. Scheduling periodic tasks in general, and harmonically compatible tasks more specifically, is discussed in further detail below.

In an embodiment, one or more tasks 116 are associated with metadata (not shown) that describes properties of the task(s) 116. The metadata may include a scheduled release time for a task 116, i.e., a time when the task is projected to go “live” and become available for execution. Alternatively or additionally, the metadata may include a deadline for a given task 116, i.e., a time by which the task 116 is expected to be completed. For example, the deadline may be tied to a service-level agreement (SLA) between a tenant 112 and an entity operating server 102. Alternatively or additionally, the deadline may be a function of the task 116 being a prerequisite for another task 116. The dependent task 116 may have a fixed start time by which execution of the first task 116 must be completed.

In an embodiment, telemetry utility 106 refers to hardware and/or software configured to perform operations for generating historical telemetry data 118. In general, telemetry refers to the process of collecting and transmitting data from one or more specified sources (e.g., shared resources 104) for analysis, monitoring, and/or further action. Specifically, telemetry utility 106 is configured to perform telemetry by monitoring task 116 execution and/or shared resources 104, to obtain historical telemetry data 118. Historical telemetry data 118 may describe, for example, the status, performance, behavior, and/or condition of tasks 116 and/or shared resources 104 over a given time. Historical telemetry data 118 may include processor utilization data, memory utilization data, network bandwidth utilization data, data that describes task 116 start and completion times, etc.

Based on historical telemetry data 118, one or more embodiments are configured to compute usage statistics 136. Usage statistics 136 indicate how tasks 116 and/or shared resources 104 have performed historically. For example, usage statistics 136 may include average processing times, best-case processing times, worst-case processing times, average resource utilization, best-case resource utilization, worst-case resource utilization, etc. A given usage statistic 136 may correspond to an individual task 116, multiple tasks 116, a particular shared resource 104, and/or multiple shared resources 104. In an embodiment, for each task 116, usage statistics 136 include an average worst-case execution time.

In an embodiment, a CP model generator 108 refers to hardware and/or software configured to perform operations for generating a constraint programming model 120. Specifically, CP model generator 108 is configured to generate a constraint programming model 120 that represents a periodic scheduling problem associated with tasks 116. Constraint programming model 120 is written to a specification supported by a CP solver 110, so that the CP solver 110 may be applied to constraint programming model 120 to obtain a CP solution 132 to the periodic scheduling problem. CP solver 110 is discussed in further detail below.

Constraint programming model 120 may include one or more constrained variables. Constrained variables are variables whose assigned values are restricted to a particular domain of possible values. For example, constraint programming model 120 may include task assignment variables 122 that include a set of numeric decision variables corresponding to task assignments, i.e., which resource 104 each task 116 is assigned to. This set of variables is in the order of the number of tasks 116, where each task 116 is associated with a corresponding domain that represents the available resources 104.

Specifically, each possible value in the domain of a task assignment variable 122 may correspond to a unique identifier of a shared resource 104, such as a processor. In some cases, the unique identifier may simply be an index number assigned to each shared resource 104. For a given task 116, the corresponding value of the variable indicates a shared resource 104 to which that task is assigned. In this case, the domain of each variable runs from the lowest possible index (e.g., zero) to the highest index associated with a shared resource 104. For example, if shared resources 104 include ten processors, the domain of each variable may run from zero to nine.

In an embodiment, the set of task assignment variables 122 is further restricted by a task assignment constraint 123, which helps ensure that no resource is overbooked by the tasks 116. One possible form of the task assignment constraint 123 is a bin packing constraint. With a bin packing constraint, each shared resource 104 is considered a bin and each task 116 assigned to that resource 104 is considered an item in the bin. In this approach, system 100 may treat the periodic scheduling problem as a bin-packing problem. The capacity of each bin represents available capacity (e.g., compute time, if the shared resources 104 are processors) within each shared resource 104, where task weights represent their respective utilizations. One or more embodiments use task assignment constraint 123 to enforce resource utilization among collocated, harmonically compatible tasks 116, such that collocations do not exceed availability of shared resources 104 within the scheduling period. The bin packing constraint may also compute the number or amount of shared resources 104 that are actually assigned to the tasks 116, which is upper-bounded by the total available resources 104.

Constraint programming model 120 may further include execution time variables 124 that include a set of numeric decision variables corresponding to task 116 execution times within their respective periods. This set of variables is in the order of the number of tasks 116, where each task 116 is associated with a corresponding domain that represents the time within its period that the task 116 is to be executed. The domain of each of the execution time variables 124 is upper-bounded by the task 116's period. The domain may also be restricted by an execution time constraint 125, discussed in further detail below. Alternatively or additionally, the constraint programming model 120 may include one or more collocation constraints 127, which impose restrictions on collocated tasks and/or prohibit collocation of incompatible tasks. In general, a collocation constraint 127 is configured to prevent tasks assigned to a same resource 104 from overlapping with each other. Some examples of collocation constraints 127 are discussed in further detail below.

Constraint programming model 120 may include one or more search directives 128. Specifically, search directive 128 may be a preferential search directive to minimize the value of an objective function 126. Search directive 128 guides the search to first reason over high-utilization tasks. Search directive 128 may be specified in the constraint programming model 120 to determine both assignment and execution time of a given task 116 before assigning another task 116, in a manner that prefers minimal values.

As noted above, the periodic scheduling problem may be modeled as a bin-packing problem. Search directive 128 may direct the search process to order variables using First-Fit Decreasing Utilization (FFDU). FFDU applies to optimization problems where items of different sizes (e.g., tasks 116) are to be packed into a limited number of containers (or “bins”) (e.g., shared resources 104) while minimizing the number of bins used. “First-Fit” refers to the strategy of placing items into bins in the order they are encountered, trying to place each item in the first bin where it fits. If a bin is found where the item doesn't fit, a new bin is used. “Decreasing” involves sorting the items to be packed in decreasing order of size before applying the first-fit strategy. This means that larger items (e.g., tasks 116 that consume more of the shared resources 104 over a given period) are considered first, and smaller items are placed later. “Utilization” refers to how much of the available space within each bin is being used after placing an item in it. Lower utilization means that more space remains in the bin. Thus, FFDU sorts the items in decreasing order of size and then uses the first-fit strategy to place the items into bins, aiming to achieve bins with relatively low utilization (i.e., more space left).

In an embodiment, objective function 126 may be expressed as min (§ CC[i]), where CC[i] represents per-tenant cost elements and i corresponds to tenants in a computing system. Alternatively, objective function 126 may be represented as min (TC), where TC represents total cost element 130. Objective function 126 may be configured to minimize the value of a total cost element 130.

In an embodiment, total cost element 130 represents the total cost of a given solution to the periodic scheduling problem. For example, the total cost may correspond to total, average, and/or peak resource utilization. One or more embodiments constrain total cost element 126 to the peak number of shared resources 104 predicted to be consumed when executing the tasks 116. A domain of total cost element 130 indicates possible total costs of the solution, with a minimum value of zero and a maximum value corresponding to the maximum possible value of the metric being used to measure total cost. The maximum value may be based on usage statistics 136 associated with the tasks 116 to be scheduled. Search directive 128 may direct the search process to find a CP solution 132 associated with a minimum value of total cost element 130. Thus, total cost element 130 allows the periodic scheduling problem to function as a constraint optimization problem in which CP solution 132 optimizes for reducing the peak number of shared resources 104 utilized.

In an embodiment, a CP solver 110 refers to hardware and/or software configured to generate a CP solution 132 to a periodic task scheduling problem, based on constraint programming model 120. Specifically, CP solver 110 is configured to receive, as input, constraint programming model 120 and produce, as output, CP solution 132. Examples of operations for constraint programming solving are discussed in further detail below.

In an embodiment, CP solution 132 includes one or more data structures (e.g., arrays, database entries, and/or another kind of data structure or combination thereof) that represent(s) a solution to the periodic scheduling problem for the tasks 116 to be scheduled. CP solution 132 indicates how the tasks 116 are to be allotted across the shared resources 104, including start times for each task 116. Server 102 may be configured to apply CP solution 132, i.e., bring the schedule “live,” with or without first requiring user approval of CP solution 132.

In an embodiment, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 2.2. Data Storage

In an embodiment, a data repository 114 is any type of storage unit and/or device (e.g., a file system, database, collection of tables, and/or any other storage mechanism) for storing data. As illustrated in FIG. 1, the data repository 114 may be configured to store tasks 116, historical telemetry data 118, CP solution 132, usage statistics 136, and/or constraint programming model 120. Some examples of these data elements are discussed in further detail herein.

The data repository 114 may include multiple different storage units and/or devices. The multiple different storage units and/or devices may or may not be of the same type or located at the same physical site. The data repository 114 may be implemented or executed on the same computing system as server 102 and/or on a computing system separate from server 102. The data repository 114 may be communicatively coupled to server 102 via a direct connection or via a network. Information describing various data elements may be implemented across any of the components of the system 100. However, this information is illustrated within the data repository 114 for purposes of clarity and explanation.

### 2.3. User Interface

In an embodiment, interface 134 refers to hardware and/or software configured to facilitate communications between a user and server 102. Interface 134 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 134 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 134 is specified in one or more other languages, such as Java, Python, C, or C++.

### 2.4. Tenants

In an embodiment, a tenant 112 is a corporation, organization, enterprise, or other entity that accesses a shared computing resource, such as shared resources 104. The system 100 may include multiple tenants 112 that are independent from each other, such that a business or operation of one tenant is separate from a business or operation of another tenant.

### 3. CONSTRAINT PROGRAMMING-BASED PERIODIC TASK SCHEDULING

### 3.1. Scheduling Overview

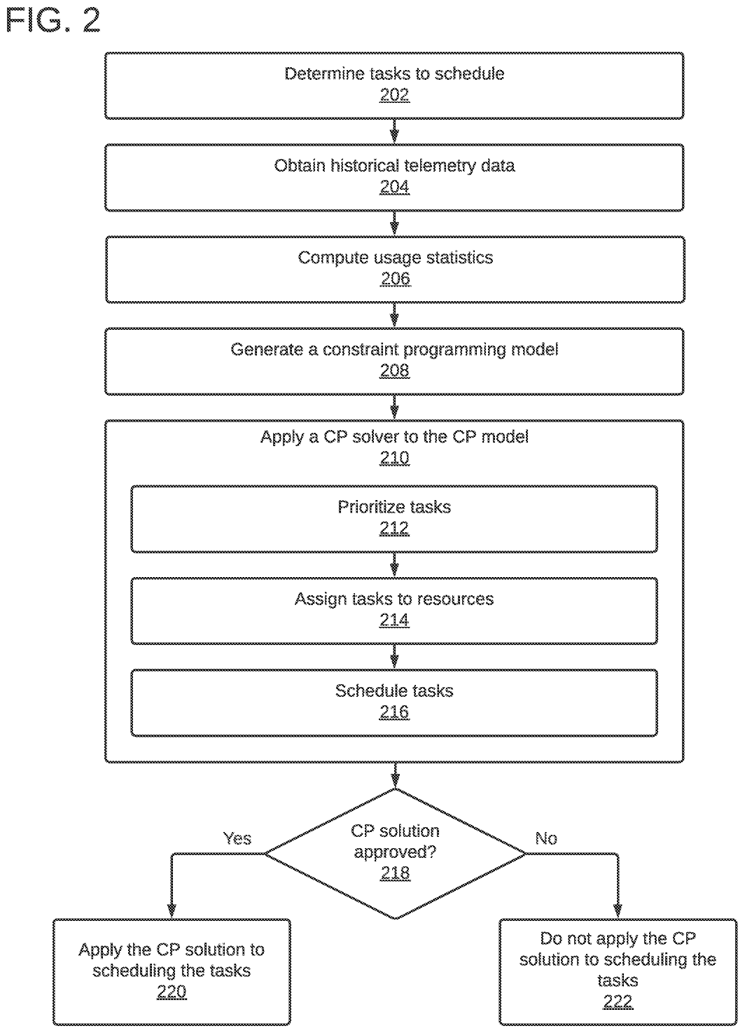

FIG. 2 illustrates an example set of operations for constraint programming-based periodic task scheduling in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

In an embodiment, a system (e.g., one or more components of system 100 illustrated in FIG. 1) determines a set of tasks to be scheduled (Operation 202). For example, the set of tasks to be scheduled may include all the tasks that are currently active within the system. To determine the set of tasks to be scheduled, the system may query a data repository in which tasks are stored. The query may be configured to request information about all tasks that are currently active.

In an embodiment, the system obtains historical telemetry data (Operation 204). To obtain historical telemetry data, a telemetry utility may monitor task execution and/or shared resources. The telemetry data may obtain information from one or more physical sensors, system logs, operating system utilities (e.g., a performance monitor), etc.

In an embodiment, the system computes usage statistics (Operation 206) based on the historical telemetry data. For example, the system may compute average processing times, best-case processing times, worst-case processing times, average resource utilization, best-case resource utilization, worst-case resource utilization, etc. A given usage statistic may correspond to an individual task, multiple tasks, a particular shared resource, and/or multiple shared resources. In an embodiment, for each task, the system computes an average worst-case execution time.

In an embodiment, the system generates a constraint programming model (Operation 208). To generate the constraint programming model, the system may generate task assignment variables constrained by a task assignment constraint, execution time variables that each may be constrained by an execution time constraint, a set of collocation constraints, and a search directive. To generate the search directive, the system may generate an objective function and a total cost element. Example operations for generating a constraint programming model are described in further detail below.

In an embodiment, the system applies a constraint programming solver to the constraint programming model (Operation 210). Specifically, the constraint programming solver receives, as input, the constraint programming model. The constraint programming solver produces, as output, a constraint programming solution. Example operations for constraint programming solving are discussed in further detail below.

In general, the constraint programming solver generates a solution by prioritizing tasks, assigning the tasks to resources, and scheduling the tasks. To prioritize tasks (Operation 212), the search may be directed first at the tasks with highest utilizations, choosing variables in order of decreasing utilization. Further prioritization may be given to tasks with fixed execution times. Each task may be assigned (Operation 214) to the unallocated shared resource (e.g., an “empty” processor) with the lowest index where resource capacities are not exceeded and scheduling conditions are not violated. If violations occur, the task may be assigned to an unallocated shared resource of lowest index. Each task may then be scheduled (Operation 212) to the earliest start time within its period where it does not coincide with another task. Tasks are thus packed as tightly as allowed within the period horizon, thereby maximizing resource utilization.

In an embodiment, the system determines whether the constraint programming solution is approved (Operation 218). To determine whether the constraint programming solution is approved, the system may generate a user interface that presents the solution, and that includes one or more controls by which a user can approve or reject the solution. The system may determine whether the constraint programming solution is approved based on the user input. If the constraint programming solution is approved, then the system may apply the solution to scheduling the tasks (Operation 220), i.e., in the live environment. If the constraint programming solution is not approved, then the system refrains from applying the solution to scheduling the tasks (Operation 222). Alternatively, the system may be configured to apply the solution to scheduling the tasks without first requiring user approval. For example, the system may be configured to perform automated task scheduling in a process that, once initiated, proceeds without user input except in the case of an error or other interruption.

One or more embodiments may be configured to repeat the scheduling process as system conditions change (for example, as tasks are added and/or removed, shared resources are taken online and/or offline, etc.). Thus, one or more embodiments are readily adaptable to changing system conditions.

### 3.2. Generating a Constraint Programming Model

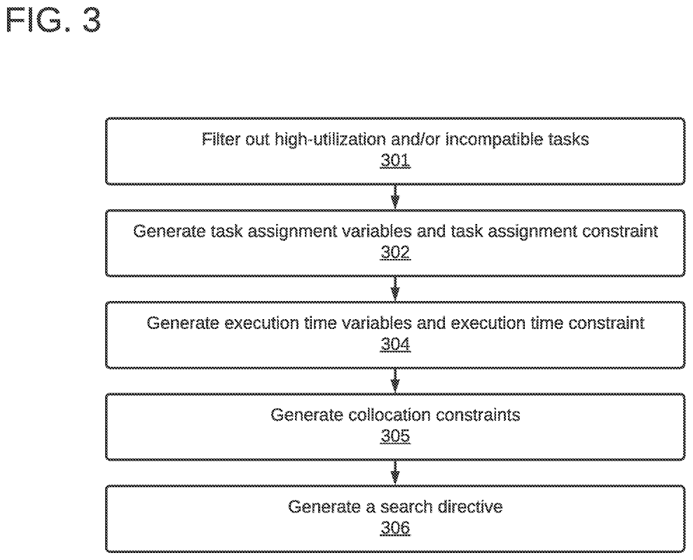

FIG. 3 illustrates an example set of operations for generating a constraint programming model in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

In an embodiment, the system filters out high-utilization tasks from the constraint programming problem (Operation 301). A high-utilization task is one that consumes a disproportionately large amount of the resource to which it is assigned. If utilization is sufficiently high that another task could not execute between iterations of the high-utilization task, then the high-utilization task requires a dedicated resource and can be excluded from the constraint programming problem. For example, one or more embodiments compute utilization as ut=d/P, where d is the duration of the task and P is the period. A higher utilization indicates that a greater portion of the period is consumed by actual execution of the task, leaving fewer resources available between subsequent iterations of the task.

Alternatively or additionally, the system may filter out incompatible tasks from the constraint programming problem. An incompatible task is a task that is incompatible with any other task to be scheduled. Specifically, two tasks are incompatible with each other if their combined durations exceed the greatest common denominator (GCD) of their periods. Given tasks ti and tj, this condition may be represented as:

$${duration}_{ti} + {duration}_{ti} > GCD ( {Period}_{ti} , {Period}_{tj} )$$

For each task, the system may test that task against every other task, to determine whether it is an incompatible task to be filtered out.

In an embodiment, the system represents task-resource assignment as a constrained variable. The system may generate task assignment variables and a task assignment constraint, with one possible form being a bin packing constraint as described herein (Operation 302). To generate the task assignment variables, the system may initialize a set of variables corresponding to task assignments, i.e., which resource each task is assigned to. This set of variables is in the order of the number of tasks, where each task is associated with a corresponding domain that represents the available resources, such that the domain of each variable is bounded by the total available resources.

In an embodiment, the system represents task execution times as a constrained variable. The system may generate execution time variables and possibly an execution time constraint applicable to each execution time variable (Operation 304). To generate the execution time constraint, the system may initialize a set of numeric decision variables corresponding to tasks' execution times within their respective periods. This set of variables is in the order of the number of tasks, where each task is associated with a corresponding domain that represents the time within its period that the task is to be executed. The domain of each variable may be upper-bounded by the task's period. The execution time constraint may further restrict the upper bound, so that the task executes entirely within its period and does not exceed its period end time.

In an embodiment, the system generates one or more collocation constraints (Operation 305), which impose restrictions on collocated tasks and/or prohibit collocation of incompatible tasks. For example, the system may prohibit collocation of tasks that are harmonically incompatible. Given tasks ti and tj, and assuming that Periodₜᵢ>Periodₜⱼ this prohibition may be represented as a constraint:

$$If ( Modulo ( {Period}_{ti} , {Period}_{tj} ) \neq 0$$

$${Resource}_{ti} \neq {Resource}_{tj}$$

Alternatively, this prohibition may be represented as a constraint:

$$If ( Modulo ( Max ( {Period}_{ti} , {Period}_{tj} ) , Min ( {Period}_{ti} , {Period}_{tj} ) ) \neq 0$$

$${Resource}_{ti} \neq {Resource}_{tj}$$

Alternatively or additionally, the system may prohibit collocation of tasks whose combined durations exceed their minimum common period. Given tasks ti and tj, and a function GCD that computes the greatest common denominator of two numbers, this prohibition may be represented as a constraint:

$$If ( {duration}_{ti} + {duration}_{tj} > GCD ( {Period}_{ti} , {Period}_{tj} ) )$$

$${Resource}_{ti} \neq {Resource}_{tj}$$

Alternatively or additionally, to help prevent resource contention and deadline violations, the system may impose anti-collision rules. Tasks that collocate on the same resource must not overlap with each other. Given tasks ti and tj, and a function GCD that computes the greatest common denominator of two numbers, this restriction may be represented as a constraint:

$${Resource}_{ti} = {Resource}_{tj} \to {Duration}_{ti} \leq ( {Start}_{tj} - {Start}_{ti} ) \% GCD ( {Period}_{ti} , {Period}_{tj} ) \leq GCD ( {Period}_{ti} , {Period}_{tj} ) - {Duration}_{tj}$$

More generally, incompatible tasks are tasks that are not periodic, that are harmonically incompatible with each other, and/or that should not be collocated for another reason. For example, given a set of tasks with a minimum common period, a task whose execution time exceeds the minimum common period would be considered incompatible with the others. In an embodiment, incompatible tasks are scheduled separately from periodic, harmonically compatible tasks, and may thus be excluded from the constraint programming problem. In general, the system filters out a task from the constraint programming problem if including that task would cause an overlap of execution periods between different tasks assigned to the same shared resource.

In an embodiment, the system generates a search directive (Operation 306). As discussed above, the search directive may include an objective function configured to minimize the value of a total cost element. Generating the search directive may include initializing the total cost element with a domain ranging from a minimum value (e.g., zero) to a maximum value (e.g., peak resource utilization).

### 3.3. Constraint Programming Solving

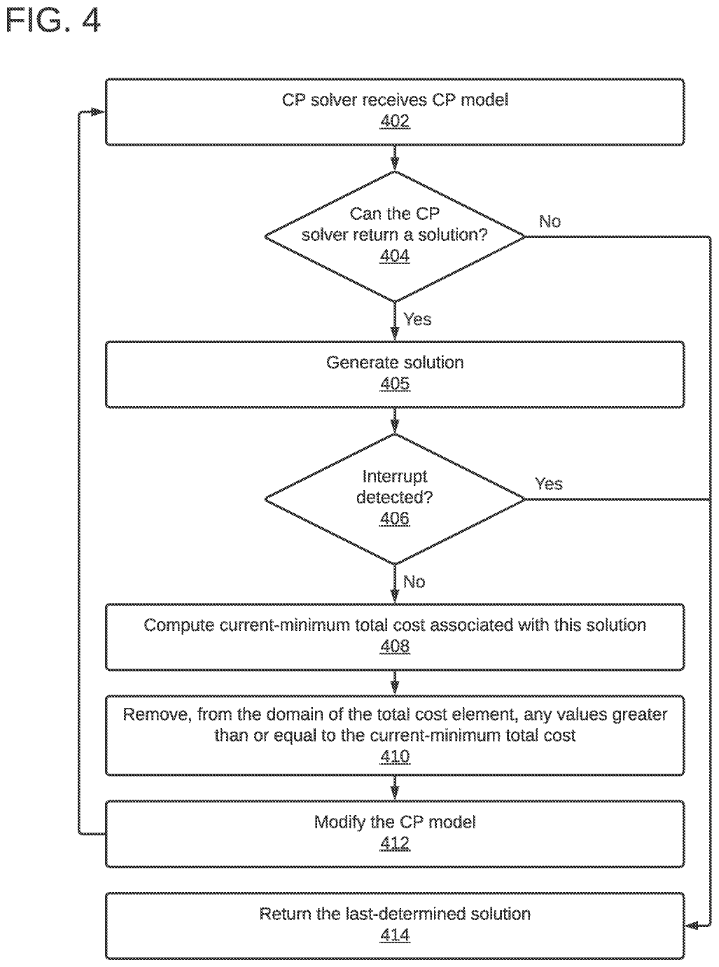

FIG. 4 illustrates an example set of operations for constraint programming solving in accordance with one or more embodiments. One or more operations illustrated in FIG. 4 may be modified, rearranged, or omitted all together. Accordingly, the particular sequence of operations illustrated in FIG. 4 should not be construed as limiting the scope of one or more embodiments.

As illustrated in FIG. 4, constraint programming solving may be an iterative process. Alternatively or additionally, one or more embodiments may be configured to perform only a single pass at finding a solution and use that solution as a “best-effort” optimization of the periodic scheduling problem.

In an embodiment, a CP solver receives a CP model (Operation 402). The system determines whether the CP solver can return a solution based on the most recently provided CP model (Operation 404). If the CP solver cannot return a solution, then the CP solver returns the last-determined solution (Operation 414). If no solution was found at all, then the system may generate an error and present the error to a user (not shown). If the CP solver can return a solution (Operation 404), then it generates that solution (Operation 405). Alternatively, determining whether the CP solver can return a solution may involve attempting to generate the solution; the CP solver is unable to return a solution if the attempt at generating a solution fails.

CP solver may be configured to use constraint programming techniques such as constraint propagation, backtracking search algorithms, and/or forward-checking algorithms. Constraint propagation involves eliminating inconsistent values from domains of data model elements in a constraint programming model. Backtracking search algorithms involve incrementally building candidates for the CP solution, including abandoning a candidate when the CP solver determines that the candidate cannot possibly be completed to provide a valid CP solution. Forward-checking algorithms involve attempting to foresee the effect of choosing one candidate over other candidates for the CP solution or determining a sequence in which to attempt candidates for the CP solution.

In an embodiment, the system determines whether an interrupt was detected (Operation 406). A user and/or an application may interrupt the iterative process. As an example, a user may indicate via a user interface that the user desires the best CP solution determined thus far, without waiting for the iterative process to complete. If an interrupt is detected, then the CP solver returns the last-determined solution (Operation 414). If no solution was found at all, then the system may generate an error and present the error to a user.

As noted above, one or more embodiments use an iterative solving process. Specifically, the iterative solving process may be configured to search for solutions that minimize the value of a total cost element. To that effect, if no interrupt was detected, then the CP solver may compute the current-total minimum cost associated with the most recent solution (Operation 408), i.e., the value assigned to the total cost element associated with the currently-determined solution. The system removes, from the domain of the total cost element, any values greater than or equal to the current-minimum total cost (Operation 410). Restricting the domain of the total cost element ensures that the search process does not consider any solution that has a higher value associated with the total cost element. The system modifies the CP model (Operation 412) to reflect the modified domain of the total cost element. The system then continues with the next iteration of the solving process by applying the CP solver to the modified CP model (Operation 402).

In an embodiment, the iterative process may continue until the CP solver can no longer return a solution (Operation 404) or an interrupt is detected (Operation 406). In the absence of an interrupt, the CP solver may iterate until all possible CP solutions have been evaluated and/or eliminated from consideration due to restriction of the domain of the total cost element.

### 4. EXAMPLE EMBODIMENTS

Detailed examples are described below for purposes of clarity. Components and/or operations described below should be understood as specific examples which may not be applicable to certain embodiments. Accordingly, components and/or operations described below should not be construed as limiting the scope of any of the claims.

### 4.1. Periodic Tasks

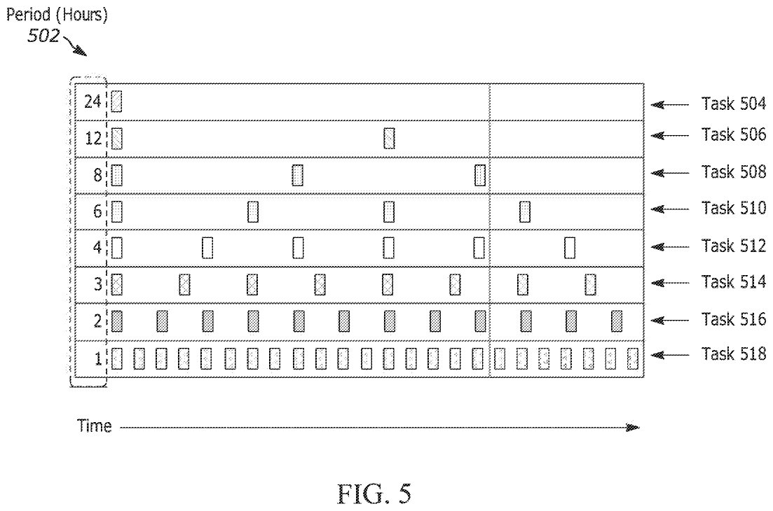

FIG. 5 illustrates an example of periodic tasks in accordance with one or more embodiments. Specifically, FIG. 5 illustrates how the periods 502 of different tasks 504-518 align with each other over time. For ease of discussion, all tasks 504-518 are assumed to have the same execution time. The periods 502 are measured in hours but could alternatively be on a different time scale. Thus, task 504 has a period of 24 hours, task 506 has a period of 12 hours, task 508 has a period of 8 hours, task 510 has a period of 6 hours, task 512 has a period of 4 hours, task 514 has a period of 3 hours, task 516 has a period of 2 hours, and task 518 has a period of 1 hour.

As discussed above, two periodic tasks are considered “harmonically compatible” if one task's period is evenly divisible by the other task's period. For example, tasks 504 and 506 are harmonically compatible because 24 is evenly divisible by 12. Tasks 504 and 508 also are harmonically compatible, because 24 is evenly divisible by 8. However, tasks 506 and 508 are not harmonically compatible, because 12 is not evenly divisible by 8. Thus, the tasks illustrated in FIG. 5 may be grouped into multiple possible sets of harmonically compatible tasks. One such set is the grouping of tasks 504 (period=24 minutes), 506 (period=12 minutes), 510 (period=6 minutes), 514 (period=3 minutes), and 518 (period=1 minute), because:
24 is evenly divisible by 12, 6, 3, and 1
12 is evenly divisible by 6, 3, and 1
6 is evenly divisible by 3 and 1
3 is evenly divisible by 1

### 4.2. Scheduling

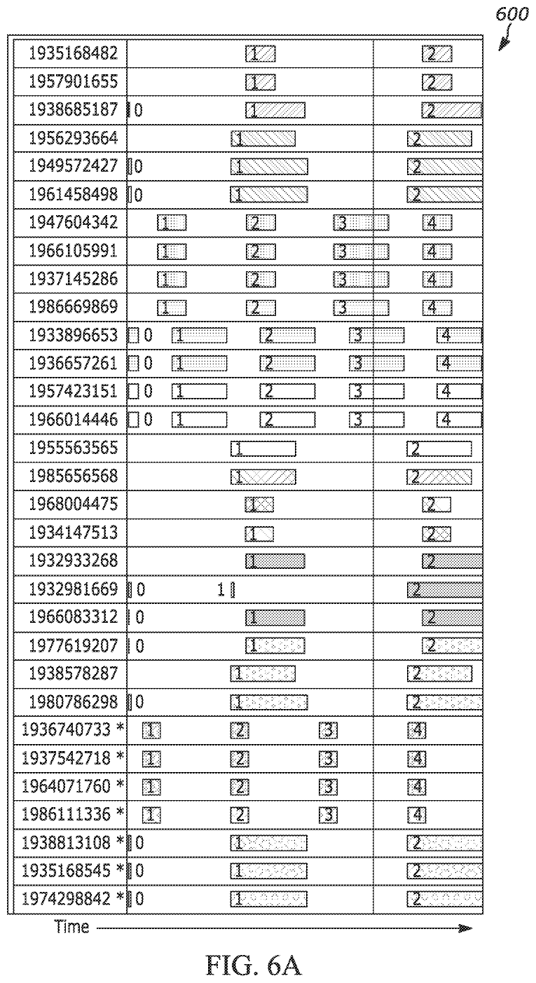

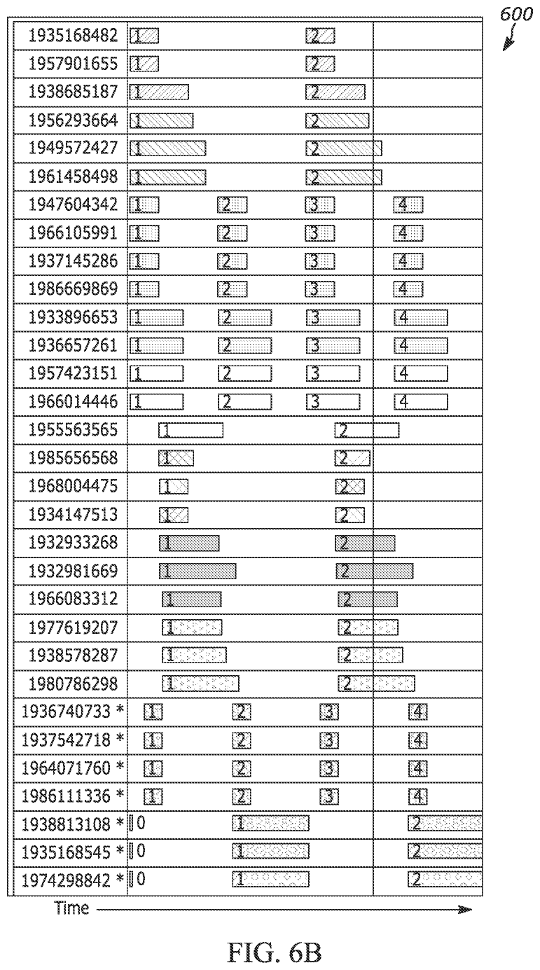

Specifically, FIGS. 6A-6B illustrate an example of constraint programming-based periodic task scheduling in accordance with one or more embodiments. Specifically, FIG. 6A illustrates a schedule for a set of tasks 600, each denoted by a numeric task identifier, before searching for a constraint programming solution. In this example, the shared resources are processors. FIG. 6B illustrates an optimized schedule for the same tasks 600 after application of constraint programming techniques described herein. In the optimized schedule, many of the tasks 600 can start sooner. In addition, resource contention is reduced. In FIG. 6A, the time period with the most concurrent tasks would require 27 processors. In FIG. 6B, the most tasks scheduled for overlapping times is 18, a 30% decrease in peak resource utilization.

### 5. PRACTICAL APPLICATIONS, ADVANTAGES, AND IMPROVEMENTS

As discussed above, one or more embodiments improve task scheduling to help optimize resource utilization in computer systems. One or more embodiments compute a start time for each task that optimizes for resource utilization, minimizes total resource needs, avoids resource contention, and meets task deadlines.

Approaches described herein may be used across a variety of technical environments. For example, one or more embodiments may be used to solve periodic scheduling problems in data management systems. One non-limiting example of such a system is Oracle Health Sciences Data Management Workbench (DMW), which helps life sciences companies manage clinical trial data. Health science companies execute clinical trials across multiple electronic data systems. Coordinating across multiple systems can lead to increased cost, greater risks, trial delays, and inefficiencies in sharing data. DMW includes features to repeatably and automatically aggregate, cleanse, combine, and transform data into a single consolidated source of truth for analysis and reporting purposes. In this example, managing clinical data starts by establishing a study, which may include several models through which data is moved. Study data loads are performed on a repeated schedule established by the customer/tenant. When many scheduled study data loads coincide, the system can reach peak resource utilization, resulting in resource contention and deadline failures. Constraint programming techniques as described herein help avoid resource contention, so that more (ideally, all) of the tasks are able to complete successfully without any missed deadlines.

### 6. COMPUTER NETWORKS AND CLOUD NETWORKS

In an embodiment, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service, such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, or a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network, such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used.

In an embodiment, each tenant is associated with a tenant identifier (ID). Each network resource of the multi-tenant computer network is tagged with a tenant ID. A tenant is permitted access to a particular network resource only if the tenant and the particular network resources are associated with the same tenant ID.

In an embodiment, each tenant is associated with a tenant ID. Each application, implemented by the computer network, is tagged with a tenant ID. Alternatively or additionally, each data structure and/or dataset, stored by the computer network, is tagged with a tenant ID. A tenant is permitted access to a particular application, data structure, and/or dataset only if the tenant and the particular data structure and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally include a single logical executable. With microservice applications, different microservices are independently deployable as separate executables. Microservices may communicate using HyperText Transfer Protocol (HTTP) messages and/or according to other communication protocols via Application Programming Interface (API) endpoints. Microservices may be managed and updated separately, written in different languages, and may be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In an embodiment, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### 7.1. Triggers

The techniques described above may be encapsulated into a microservice, according to one or more embodiments. In other words, a microservice may trigger a notification (into the microservices manager for optional use by other plugged-in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects that a value has crossed a triggering threshold.

In an embodiment, the trigger, when satisfied, may output data for consumption by the target microservice. In another embodiment, the trigger, when satisfied, outputs a binary value indicating that the trigger has been satisfied, and/or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### 7.2. Actions

In an embodiment, a plugged-in microservice application may expose actions to the microservices manager. The exposed actions may receive, as input, data or an identification of a data object or location of data that causes data to be moved into a data cloud.

In an embodiment, the exposed actions may receive, as input, a request to increase or decrease existing alert thresholds. The input may identify existing in-application alert thresholds and whether to increase, decrease, or delete the threshold. Alternatively or additionally, the input may request the microservice application to create new in-application alert thresholds. The in-application alerts may trigger alerts to the user while logged into the application or may trigger alerts to the user, using default or user-selected alert mechanisms available within the microservice application itself, rather than through other applications plugged into the microservices manager.

In an embodiment, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 8. HARDWARE OVERVIEW

According to one embodiment, the techniques described herein are implemented by one or more special-purpose computing devices. The special-purpose computing device(s) may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices, or any other device that incorporates hard-wired and/or program logic to implement the techniques.

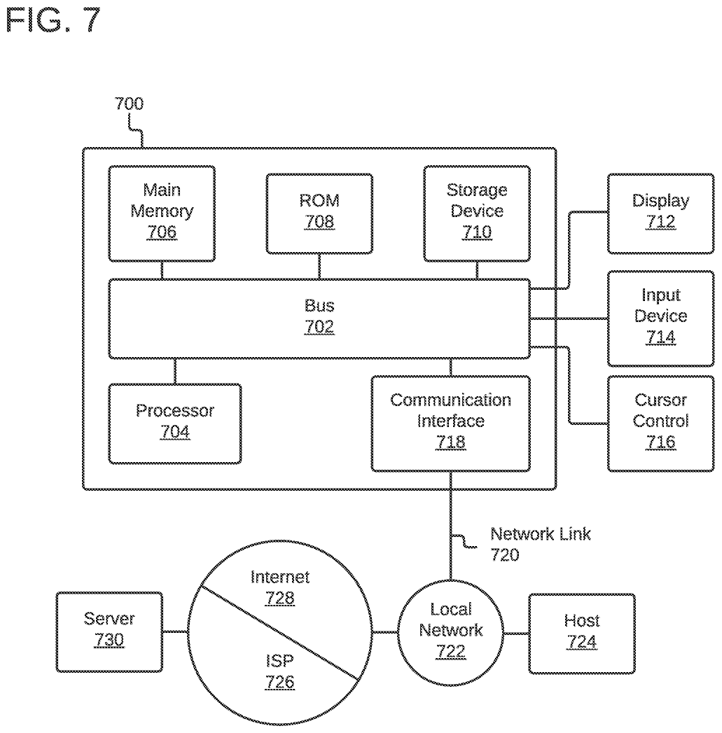

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to the processor 704, render computer system 700 into a special-purpose machine that is customized to perform the operations specified in the instructions.

Computer system 700 further includes a read only memory (ROM) 708 or other static storage device coupled to the bus 702 for storing static information and instructions for the processor 704. A storage device 710, such as a magnetic disk or optical disk, is provided and coupled to the bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware, and/or program logic which in combination with computer system 700 causes or programs computer system 700 to be a special-purpose machine. In an embodiment, the techniques herein are performed by computer system 700 in response to the processor 704 executing one or more sequences of one or more instructions contained in the main memory 706. Such instructions may be read into the main memory 706 from another storage medium, such as the storage device 710. Execution of the sequences of instructions contained in the main memory 706 causes the processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may include non-volatile media and/or volatile media. Non-volatile media includes, for example, optical or magnetic disks, such as storage device 710. Volatile media includes dynamic memory, such as the main memory 706. Common forms of storage media include, for example, a floppy disk, a flexible disk, hard disk, solid state drive, magnetic tape, or any other magnetic data storage medium, a read-only compact disc (CD-ROM), any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires of bus 702. Transmission media can also take the form of acoustic or light waves, such as those generated during radio wave and infrared data communications.

Various forms of media may be involved in carrying one or more sequences of one or more instructions to the processor 704 for execution. For example, the instructions may initially be carried on a magnetic disk or solid-state drive of a remote computer. The remote computer can load the instructions into its dynamic memory and send the instructions over a telephone line or other communications medium, using a modem. A modem local to computer system 700 can receive the data on the telephone line or other communications medium and use an infrared transmitter to convert the data to an infrared signal. An infrared detector can receive the data carried in the infrared signal and appropriate circuitry can place the data on the bus 702. The bus 702 carries the data to the main memory 706, from which the processor 704 retrieves and executes the instructions. The instructions received by the main memory 706 may optionally be stored on the storage device 710, either before or after execution by processor 704.

Computer system 700 also includes a communication interface 718 coupled to the bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card configured to provide a data communication connection to a compatible LAN. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through a local network 722 to a host computer 724 or to data equipment operated by an Internet Service Provider (ISP) 726. The ISP 726 in turn provides data communication services through the world wide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720, and communication interface 718. In the Internet example, a server 730 might transmit a requested code for an application program through the Internet 728, ISP 726, local network 722, and communication interface 718.

The received code may be executed by processor 704 as it is received, and/or may be stored in the storage device 710 or other non-volatile storage for later execution.

### 9. MISCELLANEOUS; EXTENSIONS

Embodiments are directed to a system with one or more devices that include a hardware processor and that are configured to perform any of the operations described herein and/or recited in any of the claims below.

In an embodiment, a non-transitory computer-readable storage medium stores instructions which, when executed by one or more hardware processors, cause performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause performance of operations comprising:
determining a set of tasks to be scheduled across a set of shared resources, the set of tasks comprising a plurality of periodic tasks;
filtering out one or more high-utilization tasks from the set of tasks to be scheduled;
generating a constraint programming (CP) model based on the set of tasks, the CP model comprising a set of constrained variables, a set of constraints, and a search directive;
applying a CP solver to the CP model, to obtain a CP solution for scheduling the set of tasks across the set of shared resources;
wherein the CP solution assigns two or more periodic tasks in the plurality of periodic tasks to a same resource in the set of shared resources, based at least on the two or more periodic tasks having periods that are harmonically compatible.

2. The one or more non-transitory computer-readable media of claim 1, the operations further comprising:
prohibiting collocation of any periodic tasks that are harmonically incompatible.

3. The one or more non-transitory computer-readable media of claim 1, the operations further comprising:
prohibiting any tasks in the set of tasks whose duration exceeds an upper period threshold from collocation with any periodic task in the plurality of period tasks.

4. The one or more non-transitory computer-readable media of claim 1, the operations further comprising:
without receiving user input that indicates approval of the CP solution, scheduling the set of periodic tasks as indicated by the CP solution.

5. The one or more non-transitory computer-readable media of claim 1, wherein the set of constrained variables comprises:
a first set of constrained variables corresponding to task-resource assignment;
a second set of constrained variables corresponding to task execution time.

6. The one or more non-transitory computer-readable media of claim 1, wherein the CP model further comprises a total cost element constrained to a peak number of resources consumed by the set of tasks.

7. The one or more non-transitory computer-readable media of claim 1, wherein the search directive indicates a First-Fit Decreasing Utilization (FFDU) approach to scheduling the set of tasks.

8. A system comprising:
one or more hardware processors;
one or more non-transitory computer-readable media; and
program instructions stored on the one or more non-transitory computer readable media which, when executed by the one or more hardware processors, cause the system to perform operations comprising:
determining a set of tasks to be scheduled across a set of shared resources, the set of tasks comprising a plurality of periodic tasks;
filtering out one or more high-utilization tasks from the set of tasks to be scheduled;
generating a constraint programming (CP) model based on the set of tasks, the CP model comprising a set of constrained variables, a set of constraints, and a search directive;
applying a CP solver to the CP model, to obtain a CP solution for scheduling the set of tasks across the set of shared resources;
wherein the CP solution assigns two or more periodic tasks in the plurality of periodic tasks to a same resource in the set of shared resources, based at least on the two or more periodic tasks having periods that are harmonically compatible.

9. The system of claim 8, the operations further comprising:
prohibiting collocation of any periodic tasks that are harmonically incompatible.

10. The system of claim 8, the operations further comprising:
prohibiting any tasks in the set of tasks whose duration exceeds an upper period threshold from collocation with any periodic task in the plurality of period tasks.

11. The system of claim 8, the operations further comprising:
without receiving user input that indicates approval of the CP solution, scheduling the set of periodic tasks as indicated by the CP solution.

12. The system of claim 8, wherein the set of constrained variables comprises:
a first set of constrained variables corresponding to task-resource assignment;
a second set of constrained variables corresponding to task execution time.

13. The system of claim 8, wherein the CP model further comprises a total cost element constrained to a peak number of resources consumed by the set of tasks.

14. The system of claim 8, wherein the search directive indicates a First-Fit Decreasing Utilization (FFDU) approach to scheduling the set of tasks.

15. A method comprising:
determining a set of tasks to be scheduled across a set of shared resources, the set of tasks comprising a plurality of periodic tasks;
filtering out one or more high-utilization tasks from the set of tasks to be scheduled;
generating a constraint programming (CP) model based on the set of tasks, the CP model comprising a set of constrained variables, a set of constraints, and a search directive;
applying a CP solver to the CP model, to obtain a CP solution for scheduling the set of tasks across the set of shared resources;
wherein the CP solution assigns two or more periodic tasks in the plurality of periodic tasks to a same resource in the set of shared resources, based at least on the two or more periodic tasks having periods that are harmonically compatible;
wherein the method is performed by at least one device including a hardware processor.

16. The method of claim 15, further comprising:
prohibiting collocation of any periodic tasks that are harmonically incompatible.

17. The method of claim 15, further comprising:
prohibiting any tasks in the set of tasks whose duration exceeds an upper period threshold from collocation with any periodic task in the plurality of period tasks.

18. The method of claim 15, wherein the set of constrained variables comprises:
a first set of constrained variables corresponding to task-resource assignment;
a second set of constrained variables corresponding to task execution time.

19. The method of claim 15, wherein the CP model further comprises a total cost element constrained to a peak number of resources consumed by the set of tasks.

20. The method of claim 15, wherein the search directive indicates a First-Fit Decreasing Utilization (FFDU) approach to scheduling the set of tasks.
